(19) United States
(12) Patent Application Publication
(10) Pub. No.: US 2017/0286877 A1
(43) Pub. Date: Oct. 5, 2017

(54) SYSTEM AND METHOD FOR RESOURCE PLANNING WITH SUBSTITUTABLE ASSETS

(71) Applicant: SAP SE, Walldorf (DE)

(72) Inventors: Wenjun ZHOU, Shanghai (CN); Wen-Syan LI, Shanghai (CN)

(21) Appl. No.: 15/090,439

(22) Filed: Apr. 4, 2016

(51) Int. Cl. G06Q 10/06

(52) U.S. Cl. CPC G06Q 10/0631

(57) ABSTRACT

A computer system utilizes substitutable assets as substitutes to fulfill orders for specific assets. The computer system includes a memory and a semiconductor-based processor forming one or more logic circuits. The logic circuits are configured to predict acceptability of different asset types of the substitutable assets as substitutes for the specific assets requested in each of the orders, select a pool of to-be-allocated assets including acceptable substitutable assets for the orders, and allocate selected assets from the pool to fulfill each of the orders according to a multi-objective vector optimization solution.

### BACKGROUND

Every organization has a limited number of resources (equipment, finance, personnel, time, materials, assets, etc.) that are needed to perform tasks. Resource planning involves scheduling and assigning the resources to complete a specific task. For example, for a task involving transporting a consignment of goods, resource planning may involve identifying that two hand carts and three personnel are needed and should be made available to complete the transportation task. Resource planning (scheduling and assigning resources) can have different objectives (e.g., maximizing order fulfillment rate, maximizing profit, minimizing cost, minimizing completion time, varying resource use, etc.).

In some scenarios, the resources needed to complete a task may be substitutable assets. For example, a hotel may have a hotel building with different categories or grades of rooms (e.g., standard single rooms, standard double rooms, suites, superior rooms, and executive rooms, etc.). If a customer orders or books a standard single room, the standard single room can be substituted by a higher category or grade of room (e.g., a standard double room) to satisfy the customer order. Another example is a car rental company whose assets may include different types of cars. The different types of cars may be compatible or have substitute relationships amongst each other so that one type of car (e.g., a 2-door car) can be substituted by a different type of car (e.g., a 4-door car) to fulfill a customer order.

Consideration is now being given to systems and methods for resource planning for an organization having substitutable assets for completing tasks.

### SUMMARY

A computer system for utilizing substitutable assets that can be used as substitutes to fulfill orders for specific assets is disclosed herein. The computer system includes a memory and a semiconductor-based processor which form one or more logic circuits.

In a general aspect, the logic circuits predict acceptability of different asset types of the substitutable assets as substitutes for the specific assets requested in each of the orders, select a pool or set of to-be-allocated assets, and allocate selected assets from the pool or set to fulfill each of the orders according to a multi-objective vector optimization solution. The logic circuits can predict acceptability of different asset types of the substitutable assets as substitutes for the specific assets by predicting acceptability based on historical order fulfillment information, asset compatibility information and asset upgradability information. The logic circuits may implement algorithms to allocate selected assets from the pool to fulfill each of the orders by mapping individual orders to individual assets. Each order is mapped to only one asset or none, and conversely, each asset is mapped to only one order or none. The logic circuits may further, for each order, calculate values of one or more multi-objective functions.

In an aspect of the disclosed computer system, the one or more logic circuits are configured to obtain the multi-objective vector optimization solution using particle swarm optimization to select the pool of to-be-allocated assets. Obtaining the multi-objective vector optimization solution involves initializing a position vector X and velocity vector V of a particle as an initial solution, normalizing the initial solution by rounding real values to the next highest integer value, mapping orders to assets, and separately calculating values for each of the multi-objective functions. Further, obtaining the multi-objective vector optimization solution involves calculating fitness values for each of the multi-objective functions separately, setting a personal best (pbest) for each of the multi-objective functions to a current particle position, and setting a global best(gbest) for each of the multi-objective functions to the current optimal position of the particle with each maximum objective function value.

The details of one or more implementations are set forth in the accompanying drawings and the description below. Further features of the disclosed subject matter, its nature and various advantages will be more apparent from the accompanying drawings the following detailed description, and the claims.

### BRIEF DESCRIPTION OF THE DRAWINGS

FIG. 1 is a block diagram illustration of an example system for implementing a multi-objective resource planning solution, in accordance with the principles of the present disclosure.

FIG. 2 is an example table, which lists terminology used herein to describe the systems and methods for solving the multi-objective optimization problem in accordance with the principles of the present disclosure.

FIG. 3 illustrates example tables of input data that may be available from several databases for implementing the multi-objective resource planning solution of FIG. 1.

FIG. 4 is an example table illustrating example output data which is included in the substitutable asset resource plan for the car rental company by the multi-objective resource planning solution of FIG. 1, in accordance with the principles of the present disclosure.

FIG. 5 is a flow chart illustrating an example method for generating a substitutable asset resource plan for the car rental company, in accordance with the principles of the present disclosure.

FIG. 6 is a pictorial illustration of an order and car mapping method, in accordance with the principles of the present disclosure.

FIG. 7 is an illustration of example pseudo-code for performing the method of FIG. 5, in accordance with the principles of the present disclosure.

### DETAILED DESCRIPTION

Systems and methods (collectively “resource planning solution”) for developing a resource plan (i.e. scheduling and assigning resources of an organization) to complete a task are described herein. The resources of the organization may include substitutable assets. The resource planning solution described herein may be configured to utilize the substitutable assets in the resource plan to advance one or more objectives of the organization (e.g., minimizing cost, maximizing profit, maximizing task completion rates, increasing brand value, improving customer satisfaction or other metrics, etc.). The objectives of the organization may include conflicting objectives (e.g., maximizing profit may be in conflict with minimizing cost or with improving customer satisfaction). The resource planning solution described herein may be configured to generate an optimal resource plan by balancing or trading-off advances in the multiple objectives of the organization.

For purposes of illustration, implementation of an example resource planning solution may be described herein using a car rental company as an example. The car rental company may have substitutable assets including, for example, different types and categories of rental cars. The scheduling or assigning rental cars to fulfill car rental orders may be referred to as “allocating” cars to car rental order.

The example resource planning solution may be implemented to develop resource plans completing tasks (e.g., fulfilling car rental orders or bookings) using the substitutable assets (i.e. rental cars) of the car rental company. In some instances, a customer order for a rental car may be fulfilled exactly as specified by a customer order (e.g., car brand (Buick), car category (comfort), number of seats (5) and pricing ($30/day), etc.). Generally in off-peak hours, the car rental company may have a variety of its assets (e.g., rental cars) available and may be able provide customers with the exact rental cars specified in customer orders. However, in some instances (e.g., during peak hours) the car rental company mat not be able to fulfill customer order requirements exactly because the particular car types specified in the customer orders may be out of stock or already rented out. For example, a customer order may include a request for a specific type of rental car (e.g. (Buick), car category (comfort), number of seats (5) and pricing ($30/day)). However, the car rental company may have no such car type in stock. Instead, the car rental company may have a similar or compatible type of car (e.g., car brand (Chevrolet), car category (comfort), number of seats (5) and pricing ($30/day)) available in stock, or the car rental company may have an upgraded type of car (e.g., car brand (Chevrolet), car category (luxury), number of seats (5) and pricing ($60/day)) available in stock. The car rental company could offer the similar type of car or the upgraded type of car, if immediately available, to the customer as a substitute for the specific type of car specified in the customer′ order. The allocation of the substitute rental car to satisfy a customer order may be determined (e.g., by a company representative) on an ad hoc basis, for example, based on a determination of which substitute cars are present at a rental site. Such ad hoc use of the substitutable assets may or may not meet the car rental company's business and financial objectives, particularly for instances in which a large number customer orders (e.g., hundreds or thousands) are involved. For such instances, the example resource planning solution may be configured to generate a substitutable asset resource plan for fulfilling customer orders keeping in view one or more multiple business and or financial objectives of the car rental company.

In an example implementation, the resource planning solution may be configured to generate the substitutable asset resource plan for fulfilling customer orders keeping in view three objectives or key performance metrics of the car rental company, for example, (1) maximum order fulfillment rate, (2) maximum net promoter score (NPS), and (3) maximum profit.

The objective maximum order fulfillment rate may reflect the notion that the car rental company may want to maximize order fulfillment rate as a higher order fulfillment rate means that more cars are rented out and increase revenue for the car rental company.

The objective maximum NPS may reflect the notion that a good NPS for the rental company indicates satisfied customers who may reward the car rental company with loyalty and recommendations to other customers. A higher NPS may also indicate that there are fewer dissatisfied customers who could leave the car rental company's customer base.

The objective maximum profit may reflect the notion that the car rental company may want to not only increase revenue but also increase profit. More cars rented out may increase revenue and may mean more profit for the car rental company. Further, for a given car rental order, a higher priced car rented out may yield a higher profit margin that a lower priced car rented out.

It will be noted that the above three objectives may have conflicting behaviors. Examples of conflicting behavior of the three objectives may be as follows.

Maximum Order Fulfillment Rate and Maximum NPS Conflict:

In some instances, the rental car company may not have sufficient rental cars or the right types of rental cars available in stock at the right time to fulfill a car rental order. For example, a customer order may specify a comfort car, which the car rental company may not have available or ready in time to fulfill the customer order. Fulfilling the customer order to maximize the order fulfillment rate may involve offering the customer a lower grade car as a substitute for the car specified in the order. The customer may accept the lower grade car, but may give the car rental company a lower NPS for not providing the car type specified in the customer order.

Maximum NPS and Maximum Profit Conflict:

The car rental company may increase its NPS by giving out rental cars of a higher grade or type than the car grades or types specified in the customer orders. For example, if a customer's car rental order specifies a comfort car, the car rental company may upgrade the comfort car to a luxury car for the same price as the comfort car. The customer may accept the upgrade and give a high NPS to the car rental company. However, the high NPS may come at the cost of reduced profit since the luxury car is likely to cost more than the comfort car. Conversely, if a comfort car is not available to fulfill the customer order, the car rental company may try to offer a higher grade or type of car at a full price to increase the car rental company's profit on the customer order. While the customer may accept the higher priced car, the customer will likely give a low NPS to the car rental company as not having fulfilled the customer order as requested and being compelled to pay the higher price.

In view of the conflicting behaviors of the three objectives, it may be apparent that a substitutable asset resource plan for fulfilling customer orders cannot be optimized to maximize all three objectives simultaneously. A single resource plan that simultaneously optimizes each of the multiple objectives may not exist. In example implementations, instead of seeking to maximize all three objectives simultaneously, the resource planning solution of the present disclosure may be configured to generate a substitutable asset resource plan using processes and algorithms for multi-objective optimization (also known as multicriteria, multiattribute vector, or Pareto optimization). For convenience in description herein, these techniques may be referred to hereinafter as “Pareto optimization”. In Pareto optimization, optimal decisions may be taken in the presence of trade-offs between two or more conflicting objectives. There may exist exists a (possibly infinite) number of Pareto optimal solutions for an optimization problem involving more than one objective function to be optimized simultaneously. A solution may be called nondominated, Pareto optimal, Pareto efficient or noninferior, if none of the objective functions can be improved in value without degrading some of the other objective values.

The resource planning solution (for the example case of the car rental company) of the present disclosure may be configured to collectively optimize multiple objectives (e.g., maximum order fulfillment rate, maximum NPS and maximum profit) to generate the substitutable asset resource plan for fulfilling car rental orders, instead of merely optimizing one single objective (e.g., optimizing allocation of rental cars to only maximize order fulfillment rate, optimizing allocation of rental cars to only maximize average NPS, or optimizing allocation of rental cars only to maximize profit). The resource planning solution may generate a representative set of Pareto optimal solutions, and/or quantify the trade-offs in satisfying the different objectives.

In an example implementation, the resource planning solution described herein may involve a three stage method for generating a substitutable asset resource plan using multi-objective optimization or Pareto optimization for allocating resources (i.e. allocating different type or grades of rental cars) to fulfill car rental orders. In the first stage, the acceptability or suitability of different types of rental cars as substitute cars for each order may be determined. The acceptability or suitability of different types of rental cars may be determined based on historical order data and historical NPS data. In the second stage, a set or pool of to-be-allocated rental cars may be selected from all rental cars in stock of the rental car company as candidate substitute cars for fulfilling car rental orders. In the third stage, the selected cars may be further optimized to allocate to individual car rental orders.

In an example implementation, the resource planning solution described herein may, for Pareto optimizations, utilize extensions or modifications of optimization algorithms based on particle swarm optimization (PSO) (which is often used for single objective optimization). Each particle may consist of data representing a possible solution, and a velocity value indicating how much the data can be changed, a personal best (pBest) value indicating the closest the particle's data has ever come to a target. PSO algorithms keep track of three global variables: target value or condition, global best (gBest) value indicating which particle's data is currently closest to the target, and a stopping value indicating when the algorithm should stop if the target is not found.

The optimization algorithms may solve the multi-objective maximization problem by iteratively trying to improve a candidate solution with regard to given measures of quality (e.g., the multiple objectives).

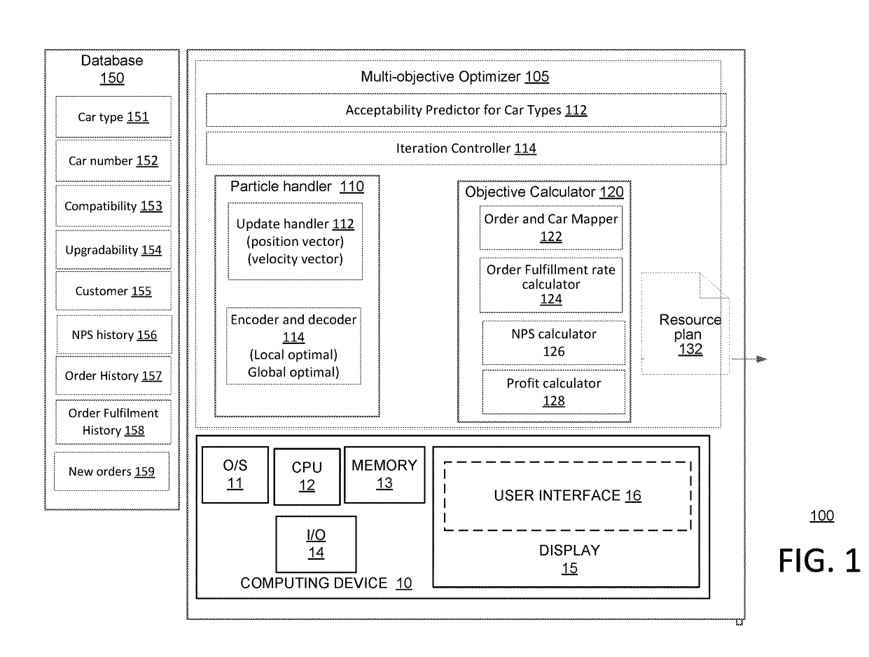

FIG. 1 shows an example system 100 for implementing a resource planning solution for allocating substitutable rental cars for fulfilling rental car orders of a car rental company, in accordance with the principles of the present disclosure.

System 100 may include a multi-objective optimizer 105, which may be configured to optimize multiple objective functions to generate substitutable asset resource plan 132 for fulfilling rental car orders for the rental car company. Multi-objective optimizer 105 may, for example, send substitutable asset resource plan 132 to personnel of the car rental company so that the rental car orders can be fulfilled at rental sites with assigned or allocated substitute rental cars as needed.

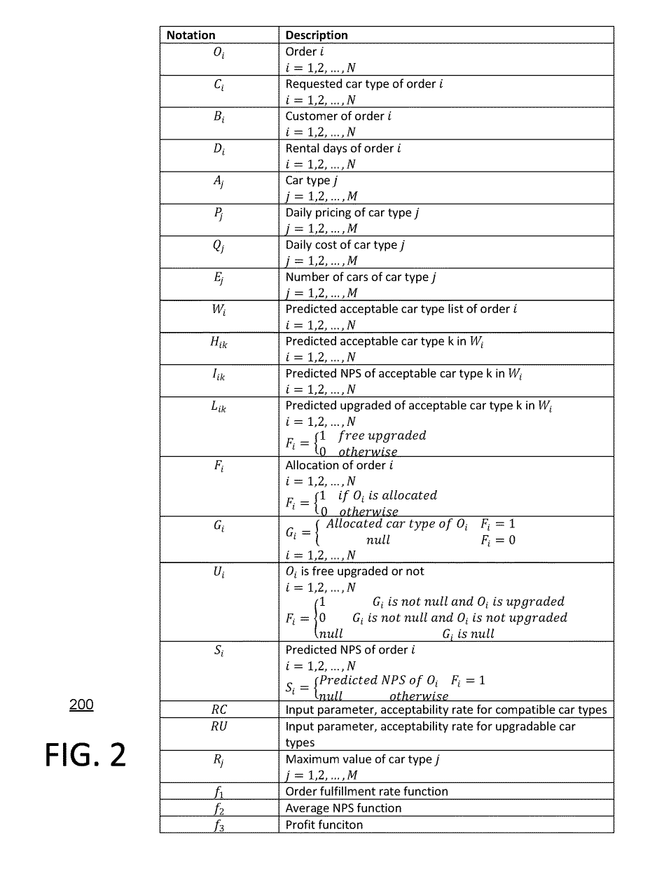

For purposes of illustration of the example objective functions and the optimization processes used by system 100 to generate substitutable asset resource plan 132, the terminology shown in FIG. 2 may be used herein.

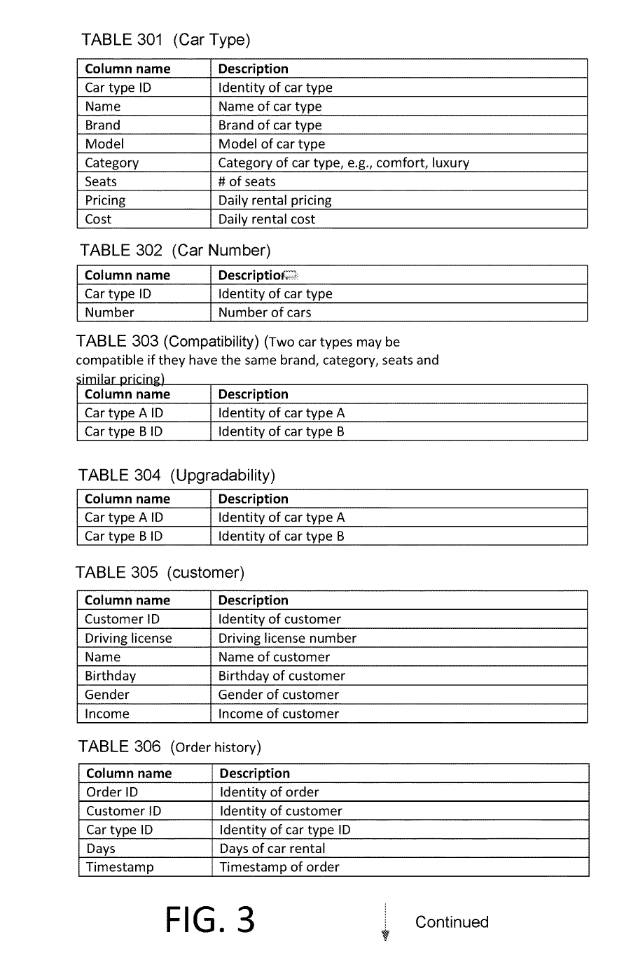

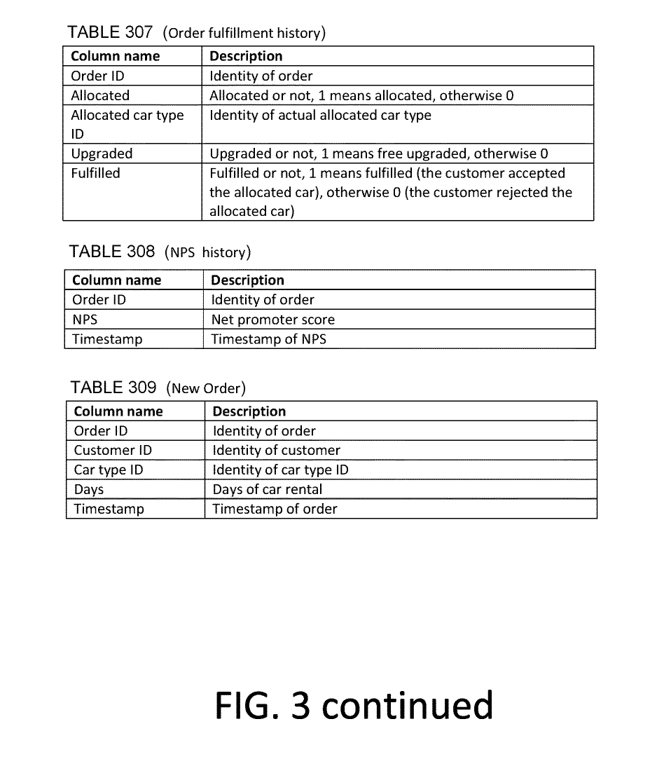

Multiple-objective optimizer 105 may generate substitutable asset resource plan 132 by processing input data retrieved from databases (e.g. database 150). The input data may, for example, include car type information, car number information, compatibility information, upgradability information, customer information, NPS history information, order history information, order fulfillment history information and new order information. This input data may, for example, be retrieved from data stores (e.g., car type 151, car number 152, compatibility 153, upgradability 154, customer 155, NPS history 156, order history 157, order fulfillment history 158 and new orders 159), which may be stored, for example, in database 150 or other databases. FIG. 3 shows Tables 301-309, which list example data fields that may be included in the car type information, car number information, compatibility information, upgradability information, customer information, NPS history information, order history information, order fulfillment history information and new order information, respectively.

Multi-objective optimizer 105 may include processes (e.g., acceptability predictor for car types 112) for predicting the acceptability (by customers) of different types or grades of the rental cars of the car rental company. Multi-objective optimizer 105 may further include an iteration controller module (e.g., iteration controller 114), an objective calculator (e.g., objective calculator 120), a particle handler (e.g., particle handler 110) and objective calculator (e.g., objective calculator 120) which include processes (e.g., order and car mapper 122, ordered fulfillment rate calculator 124, NPS calculator 126, profit calculator 128, update handler 112, and encoder and decoder 114) to iteratively search for rental cars to assign or allocate to orders as substitute cars in substitutable asset resource plan 132.

In an example scenario, it may be assumed that the car rental company's assets include M rental cars of various car types Aⱼ, j=1,2, . . . , M. Each car type Aⱼ may have a daily pricing Pⱼ and daily cost Qⱼ. At a given time, for each car type Aⱼ, there may be Eⱼ idle cars in stock, which have not been rented out yet by the car rental company. At the same time, the car rental company may have received N rental car orders Oᵢ, i=1,2, . . . , N. Each order (e.g., for customer Bᵢ) may specify a requested car type Cᵢ, and a number of rental days Dᵢ. Further, in the example scenario, it may be assumed that not all of the received N rental car orders Oᵢ can be fulfilled perfectly. In such instance, system 100 may be used to generate substitutable asset resource plan 132 to determine how the available stock of idle cars can be allocated or assigned to fulfill the car rental orders than cannot be fulfilled perfectly. System 100 may generate substitutable asset resource plan 132 by finding Pareto optimal solutions for optimizing the multiple objectives (i.e. order fulfillment rate, NPS, and profit) of the car rental company.

An example Pareto optimal solution “A” generated by system 100 may, for example, correspond to an order fulfillment rate of 80%, an average NPS of 8, and a profit of one million dollars. It will be understood that if system 100 finds another Pareto optimal solution, for example, with a higher order fulfillment rate of 81% (and an average NPS of 8, and a profit of one million dollars), then solution A would not be a Pareto optimal solution.

In an example implementation of system 100, each Pareto optimal solution may give be include the following decision variables for each order Oᵢ: order fulfillment, Fᵢ; allocated car type, Gᵢ;; upgraded, Uᵢ;; and predicted NPS, Sᵢ;.

The Pareto optimization of the multi-objectives (i.e. order fulfillment rate, NPS, and profit) may be represented as

Max(f₁,f₂,f₃),

where the order fulfillment rate f₁ is given by

$${f}_{1} = \frac{{\sum }_{i}^{N} {F}_{i}}{N} ,$$

the average NPS f₂ is given by

$${f}_{2} = \frac{{\sum }_{i}^{N} {S}_{i}}{{\sum }_{i}^{N} {F}_{i}} ,$$

and the profit f₃ is given by

f₃=Σᵢ^{N}FᵢDᵢ((1−Uᵢ)(P_{G}_{ᵢ}−Q_{G}_{ᵢ})+Uᵢ(P_{C}_{ᵢ}−Q_{C}_{ᵢ})).

Multi-objective optimizer 105 may be configured to implement a three-stage method to find Pareto optimal solutions to the foregoing multi-objectives maximization problem in conjunction with input data, which may be available, for example, from database 150.

In a first stage, multi-objective optimizer 105/acceptability predictor 112 may determine customer acceptability of various different types of rental cars for each order Oᵢ based on analysis of the historical order fulfillment, car compatibility and upgradability information. Multi-objective optimizer 105/acceptability predictor 112 may thus identify a pool of potential car types available as substitute cars for each car rental order Oᵢ. For example, if a specific car rental order Oᵢ requests car type A, multi-objective optimizer 105/acceptability predictor 112 may predict (based on the historical order fulfillment and car compatibility and upgradability information) that the customer would accept not only car type A, but also any of car types B, C and D as substitutes for car type A in the specific car rental order Oᵢ. However, for car type D, only a free upgrade may be acceptable to the customer.

In the second stage of the method to find Pareto optimal solutions, multi-objective optimizer 105/particle handler 110 may be configured to implement a modified particle swarm optimization technique to identify rental cars from the available stock of idle cars that can be allocated or assigned to fulfill the car rental orders. For example, multi-objective optimizer 105/particle handler 110 may identify that 500 of type A idle rental cars, 300 of type B idle rental cars, 200 of type C idle rental cars and 100 of type D idle rental cars are available to be allocated to all orders. Particle handler 110 may include processes or modules (e.g., update handler 112 and encoder and decoder 114) that are configured to carry out the modified particle swarm optimization technique under supervisor of iteration controller 114.

In the third stage of the method to find Pareto optimal solutions, multi-objective optimizer 105/objective calculator 120 may be configured to optimize allocation of cars (i.e., cars identified in stage two) to specific orders. For this purpose, objective calculator 120 may include processes (e.g., order and car mapper 122) to map orders to cars, and processes (e.g., order fulfillment rate calculator 124, NPS calculator 126, and profit calculator 126) to calculate, for example, the order fulfillment rate, average NPS and profit.

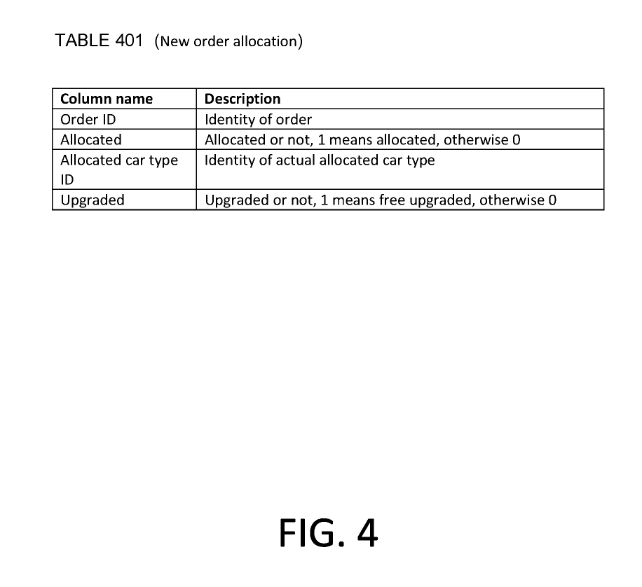

System 100 may include the optimized allocation of cars in substitutable asset resource plan 132 for fulfilling rental car orders for the rental car company. FIG. 4 shows Table 401, which lists, for example, data fields that may be included in substitutable asset resource plan 132 for each car rental order Oᵢ. As shown in the table, substitutable asset resource plan 132 in addition to identification of each order (e.g., order ID) may include information identifying whether a rental car available in stock is allocated to the order, identification of an actual allocated car (e.g., allocated car type ID), and an indication of whether the allocated car represents an upgrade to car requested in the order.

In system 100, multi-objective optimizer 105 and other system components (e.g., database 150, etc.) may be hosted on one or more standalone or networked physical or virtual computing machines. FIG. 1 shows, for example, multi-objective optimizer 105 hosted on a computing device 10 (e.g., a desktop computer, a mainframe computer, a server, a personal computer, a mobile computing device, a laptop, a tablet, or a smart phone), which may be available to a user. Computing device 10, which includes an O/S 11, a CPU 12, a memory 13, and I/O 14, may further include or be coupled to a display 15 (including, for example, a user interface 16). The resource plan (e.g., substitutable asset resource plan 132) generated by multi-objective optimizer 105 may be presented to the user, for example, on user interface 16.

Moreover, although computer 10 is illustrated in the example of FIG. 1 as a single computer, it may be understood that computer 10 may represent two or more computers in communication with one another. Therefore, it will also be appreciated that any two or more components of system 100 may similarly be executed using some or all of the two or more computing devices in communication with one another. Conversely, it also may be appreciated that various components (e.g., database 150, etc.) illustrated as being external to computer 10 may actually be implemented therewith.

Multi-objective optimizer 105 may be linked, for example, via Internet or intranet connections, to database 150. Further, multi-objective optimizer 105 may be linked to data sources on the web (e.g., worldwide and/or enterprise webs) and/or or other computer systems of the organization (e.g., e-mail systems, human resource systems, material systems, operations, etc.) that may have information relevant to the generation and implementation of the resource plan (e.g., substitutable asset resource plan 132).

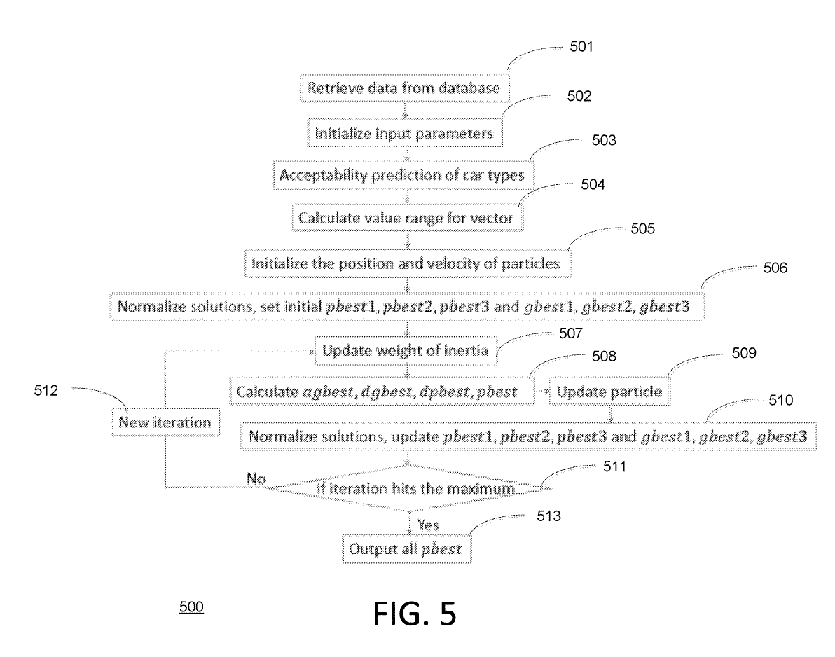

FIG. 5 shows an example method 500 for generating a substitutable asset resource plan keeping in view multiple business and financial objectives of a company, in accordance with the principles of the present disclosure.

Method 500 may utilize multi-objective optimization techniques to determine an optimal substitutable asset resource plan which conforms to the multiple business and financial objectives of the company.

Example implementations of method 500 are described herein using the example of the car rental company having a fluctuating stock of rental cars at hand for fulfilling car rental orders for customers. The car rental company may have three business objectives (e.g., maximizing order fulfillment rate, maximizing NPS, and maximizing profit) in implementing the substitutable asset resource plan for fulfilling car rental orders.

Method 500 may be implemented in three stages using, for example, system 100.

In the first stage of method 500, customer acceptability of different cars types as substitute cars for each order may be determined. The potential allocated car types for each specific car rental order may be defined in this stage. For example, if a requested car type of the specific car rental order is car type A, based on the historical order fulfillment information and car compatibility and upgradability information, method 500 may determine or predict that the customer would accept not only the requested car type A, but also accept car types B, C and D as substitutes. For car type D, the method may determine or predict that only a free upgrade may be acceptable to the customer.

In the second stage of method 500, a modified particle swarm optimization technique may be used to select to-be-allocated rental cars from all idle rental cars of the car rental company that may be available for fulfilling the car rental orders. The method may determine, for example, that 500 cars of type A, 300 cars of type B, 200 cars of type C and 100 cars of type D are in a potential pool of cars that be allocated to all pending the car rental orders.

In the third stage of method 500, individual cars in the potential pool of cars allocated to all pending the car rental orders may be optimized for allocation to specific car rental orders. In this third stage, method 500 may map the specific car rental orders to cars, and then calculate values of the key multi-objectives (e.g. order fulfillment rate, average NPS and profit).

The second and third stages of method 500 may be performed consecutively in a single iteration cycle (e.g., under the supervision of iteration controller 114 in system 100).

### Method 500, First Stage

Method 500, which may involve computer-implemented multi-objective optimization algorithms, may include retrieving input data from a database (501) and initializing the input data 502. The input data may include, for example, car type information, car number information, compatibility information, upgradability information, customer information, NPS history information, order history information, order fulfillment history information and new order information, etc. Examples of the input data are shown in Tables 301-309 (FIG. 3).

Method 500 may further include determining customer acceptability of different car types as substitutes for the specific car types requested in customer orders for rental cars (503). In example implementations, determining the customer acceptability of different car types 503 may involve determining an acceptable car type list or set Wᵢ, i=1,2, . . . , N for each Oᵢ, and determining details of each element Wᵢ including the car type Hᵢₖ, NPS Iᵢₖ, and upgraded or not Lᵢₖ. for each Oᵢ. The determination may be based on the following algorithm steps:
a. For each Oᵢ, initialize Wᵢ by inserting Cᵢ and all compatible and upgradable car types of Cᵢ into Wᵢ. Each Wᵢ may consists of several Hᵢₖ,
b. Process compatible car types:
   i. For each compatible car type, search for records whose customer ID equals Bᵢ and allocated car type ID equals Hᵢₖ in the order history table and order fulfillment history table.
   ii. Based on step i, for each Hᵢₖ which appeared in the history tables, calculate the actual acceptability rate. If the actual acceptability rate is equal or higher than RC, keep Hᵢₖ. Otherwise remove Hᵢₖ from Wᵢ.
   iii. For each remaining Hᵢₖ in step ii, predict NPS Iᵢₖ. Iᵢₖ equals the historical average NPS.
   iv. For each Hᵢₖ which has not appeared in the history tables, keep Hᵢₖ, Iᵢₖ equals the historical average NPS of all other compatible car types.
c. Process upgradeable car types:
   v. For each upgradable car type, search records whose customer ID equals Bᵢ and allocated car type ID equals Hᵢₖ in the order history table and order fulfillment history table.
   vi. Based on step i, for each Hᵢₖ which appeared in the history tables, calculate the actual acceptability rate. If the actual acceptability rate is equal or greater than RU, keep Hᵢₖ. Otherwise remove Hᵢₖ from Wᵢ.
   vii. For each remaining Hᵢₖ in step ii, predict upgradable Lᵢₖ. If upgraded times is greater than non-upgraded times, Lᵢₖ=1. Otherwise Lᵢₖ=0.
   viii. For each remaining Hᵢₖ in step ii, predict NPS Iᵢₖ. If Lᵢₖ=1, Iᵢₖ equals the historical average NPS of upgraded orders. If Lᵢₖ=0, Iᵢₖ equals the historical average NPS of non-upgraded orders.
   ix. For each Hᵢₖ which has not appeared in history, keep Hᵢₖ, Iᵢₖ equals the historical average NPS of all other upgradable car types. Set Lᵢₖ=1.

### Example Scenario

For purposes of illustration of the foregoing algorithm, consider order O₁ in an example scenario in which RC=0.6, RU=0.8, and C₁=car type A. Car type A may be compatible with car types B, C and D (e.g., as may be determined by reference to compatibility information in database 150, Table 303 (FIG. 3)), and may be upgradable to car types E or F (e.g., as may be determined by reference to upgradeability information in database 150, Table 304 (FIG. 3)). Table 1 (shown below) includes historical order fulfillment information on orders for which the allocated car type was one of car types A, B, C, D, E, and F (e.g., as may be determined by reference to historical order fulfillment information in database 150, Table 305 (FIG. 3)).

TABLE I
(historical order fulfillment)

| | | Allocated | | |
|---|---|---|---|---|
| Order | | car | | |
| ID | Allocated | type ID | Upgraded | Fulfilled |
| 1 | 1 | A | 0 | 1 |
| 2 | 1 | B | 0 | 1 |
| 3 | 1 | B | 0 | 0 |
| 4 | 1 | B | 0 | 1 |
| 5 | 1 | C | 0 | 0 |
| 6 | 1 | E | 0 | 1 |
| 7 | 1 | E | 1 | 1 |
| 8 | 1 | E | 1 | 1 |

Table 2 (shown below) includes historical NPS information (e.g., as may be determined by reference to historical NPS information in database 150, Table 308 (FIG. 3)).

TABLE II
(historical NPS)

| Order | |
|---|---|
| ID | NPS |
| 1 | 8 |
| 2 | 7 |
| 3 | null |
| 4 | 8 |
| 5 | null |
| 6 | 5 |
| 7 | 6 |
| 8 | 7 |

In the foregoing example scenario, at algorithm step a, initializing W₁ (by inserting C₁ and all compatible and upgradable car types of C₁ into W₁) may result in W₁=<A, B, C, D, E, F>. Further, algorithm step b relates to processing compatible car types (e.g., car types A, C and D). At algorithm step b.i, search for records whose customer ID equals Bᵢ and allocated car type ID equals Hᵢₖ in the order history table and order fulfillment history table (using Hᵢₖ=car type B, as an example) may result in the records shown in Table III below.

TABLE III

| | | Allocated | | |
|---|---|---|---|---|
| Order | | car | | |
| ID | Allocated | type ID | Upgraded | Fulfilled |
| 2 | 1 | B | 0 | 1 |
| 3 | 1 | B | 0 | 0 |
| 4 | 1 | B | 0 | 1 |

Further, at algorithm step b.ii, evaluation of the actual historical acceptability rate of different car types (as seen, for example, by evaluating entries in the last column of Table I or Table III) may indicate that the actual historical acceptability rate of car type B is 2/3 while that of car type C is 0. Since the actual historical acceptability rate of car type B (2/3) is greater than RC (0.6), algorithm step b.ii would leave car type B in set W₁. Conversely, since the actual historical acceptability rate of car type C(0) is less than RC (0.6), algorithm step b.ii would leave remove car type C from set W₁. Further, at algorithm step b.iii, evaluation of historical NPS data (e.g., Table II) may indicate that car type B has an average historical NPS h_{1B}=(7+8)/2=7.5. At algorithm step b.iv, evaluation of historical NPS data (e.g., Table II) for car type D, which has not been previously allocated, may be determined as the average of the average historical NPS for car types A, B and C (e.g., 8, 7.5 and 0, respectively). This may lead to assigning a NPS value: I_{1D}=(7.5+8)/2=7.75 to car type D. Thus, in the example scenario, at the end of algorithm step b, W₁=<A, B, D, E, F>, where car types A, B and C have predicted or projected NPS values of 8, 7.5, 7.75, respectively.

Next in the example scenario, algorithm step c relates to processing upgradeable car types (e.g., car types E and F). At algorithm step c.i, search for records whose customer ID equals Bᵢ and allocated car type ID equals Hᵢₖ in the order history table and order fulfillment history table (using Hᵢₖ=car type E, as an example) may result in the records shown in Table IV below.

TABLE IV

| | | Allocated | | |
|---|---|---|---|---|
| Order | | car | | |
| ID | Allocated | type ID | Upgraded | Fulfilled |
| 6 | 1 | E | 0 | 1 |
| 7 | 1 | E | 1 | 1 |
| 8 | 1 | E | 1 | 1 |

Further, at algorithm step c.ii, evaluation of the actual historical acceptability rate of different car types (as seen, for example, by evaluating entries in the last column of Table I or Table IV) may indicate that the actual historical acceptability rate of car type E is 3/3=1. Since the actual historical acceptability rate of car type E (1) is greater than RC (0.6), algorithm step c.iii would leave car type E in set Wᵢ.

Next, algorithm step c.iii relates to predicting upgradable Lᵢₖ for each Hᵢₖ remaining after algorithm step c.ii. For car type E, since the number of upgraded times (2) is greater than the number of times not upgraded (1) (as seen, for example, in Table IV) algorithm step c.iii may, for example, determine Lᵢₖ=1. At algorithm step c.iv, evaluation of historical NPS data (e.g., Table II) may lead to assigning a NPS value: I_{1D}=(6+7)/2=7.75 to car type E. At algorithm step c.v, since car type F has not been previously allocated car type F is kept in W₁. Car type F may be assigned Lᵢₖ=1 and a NFS value equal to the average NPS of car type E (i.e. I_{1F}=average I_{1E}=6.5)

Thus, in the example scenario, at the end of algorithm step c, W₁=<A, B, D, E, F>, where car types A, B and C have predicted or projected NPS values of 8, 7.5, 7.75, respectively, and where both car types E and F have upgraded property=1 and both car types E and F have predicted or projected NFS values=6.5.

### Method 500, Second Stage (Encoding and Decoding)

With renewed reference to FIG. 5, method 500 may further include calculating a value range for a vector (504) and initializing the position and velocity of particles (505) for purposes of executing a modification of particle swarm optimization of the multiple objectives of the car rental company. How many cars need to be allocated for each car type may be calculated by executing the modification of particle swarm optimization.

For the case where there are M car types Aⱼ, j=1,2, . . . , M, a position vector X may be encode or expressed as shown in Table V below:

TABLE V
(position vector X)

| Car type | 1 | 2 | . . . | M |
|---|---|---|---|---|
| Number of cars | 523 | 312 | | 108 |

The values of the number of cars (e.g., 523, 312, and 108, etc.) in the vector may correspond to the numbers of cars of each car type Aⱼ (e.g., 1, 2 and M, respectively) that are allocated to be used as cars (e.g., including as substitute cars) for fulfilling car rental orders. The value range for each car type Aⱼ may be 0 to a maximum number Rⱼ. In other words Rⱼ may represent the maximum potential number of cars of car type Aⱼ that can be allocated.

In method 500, calculating a value range for a vector 504 may include determining Rj as follows: R₁=Σᵢ^{N}(1|Wᵢ contains Aⱼ).

Since the value of each dimension in the position vector X can be a real number value x, decoding position vector X may include normalizing the real number x to the nearest higher integer value (since cars can be allocated or used only in integer units and not as a fraction of a car).

For example, before normalization, a position vector X may be as shown in Table V below:

TABLE VI
(position vector X)

| Car type | 1 | 2 | . . . | M |
|---|---|---|---|---|
| Number of cars | 522.85 | 311.09 | | 107.22 |

which after normalization would be decoded by rounding each real value to the nearest higher integer, for example, as shown in Table V:

| Car type | 1 | 2 | . . . | M |
|---|---|---|---|---|
| Number of cars | 523 | 312 | | 108 |

Calculating a value range for a vector 504, and initializing the position and velocity of particles 505 may be implemented by particle handler 110 components (update handler 112, encoder and decoder 114, etc.) in system 100.

Method 500 may further include normalizing solutions (506) and setting initial pbest1, pbest 2, pbest 3 and gbest 1, gbest 2, gbest 3.

Further, method 500 may include
508: Updating weight of inertia;
509: Updating particle; 510:
Normalizing solutions (e.g. updating pbest1, pbest2, and pbest 3, and gbest 1, gbest 2 and gbest3); and
511: checking whether the iteration has hit a maximum number of iterations.

If the iteration has not hit the maximum number of iterations at 511, method 500 may include initiating a new round of iteration (512) beginning with updating weight of inertia 508.

### Method 500, Third Stage (Mapping Orders to Cars)

The resource planning solution of method 500 includes not only calculating the allocated number of each car type but also includes calculation of values of Fᵢ, Gᵢ, Uᵢ and, Sᵢ for each car rental order Oᵢ. The value of Fᵢ corresponds to a decision whether a substitute car is allocated to Oᵢ or not. The value of Gᵢ corresponds to which car type from the acceptable car types is allocated to Oᵢ. Values of Uᵢ and Sᵢ may be obtained from the results of the first stage of method 500.

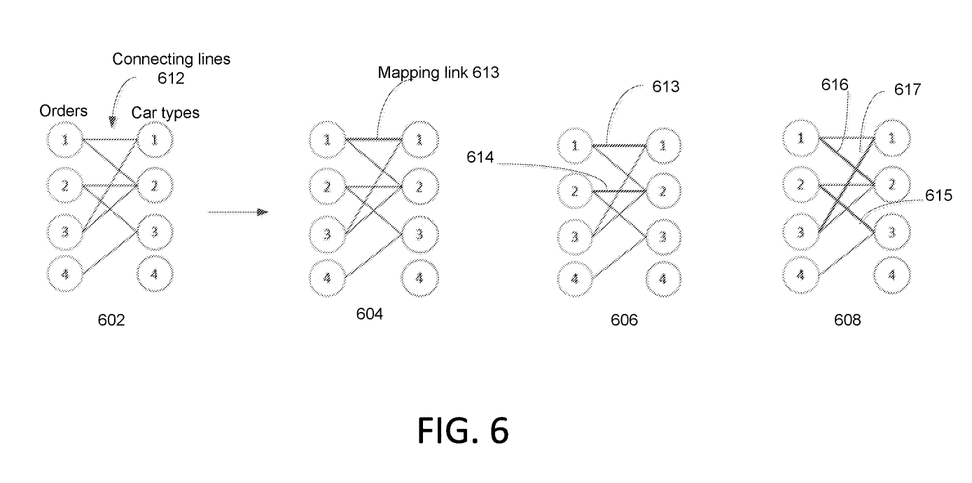

Further, method 500 may involve mapping orders to allocated cars. The processes of mapping of orders may be illustrated pictorially (FIG. 6) by the following order-car mapping algorithm steps:
i. List all new orders by order ID. Each order may be represented as a node.
ii. List all selected car types by car type ID. Each car may be represented as a node.
iii. Based on the results of the first stage of method 500, connect each order node with all car nodes whose car type is included in the predicted acceptable car types for the order with lines.
iv. Map orders to cars from top to bottom. Each order may be mapped to only one car or mapped to none. Conversely, each car may be mapped to only one order or mapped to none. A mapping rule may be as follows: If there are to-be-allocated cars left for the order, choose the highest line. If there is only one to-be-allocated car left, choose that line. If there is no to-be-allocated car left, try to let the allocated order choose another car in the recursive way.

### Example Scenario—Order to Car Mapping

For purposes of illustration of the foregoing algorithm, consider an instance where there are four 4 orders (e.g., Order 1, Order 2, Order 3 and Order 4) and four car types (e.g., car type 1, car type 2, car type 3, and car type 4). The predicted acceptable car types (determined at the first stage of method 500) for the orders may be follows: Order 1 (car types 1 and 2); Order 2 (car types 2 and 3); Order 3 (car types 1 and 2); and Order 4 (car type 3). After decoding in stage 2 of method 500 may result in the following vertex, which shows that there is only one car of each car type available in stock:

| Car type | 1 | 2 | 3 | 4 |
|---|---|---|---|---|
| Number of cars | 1 | 1 | 1 | 1 |

FIG. 6 shows, for this example scenario, the results of the foregoing order-car mapping algorithm as an order node-car type node network. Network 602 shows, for example, order nodes (e.g., (e.g., Order 1, Order 2, Order 3 and Order 4) and car type nodes (e.g., car type 1, car type 2, car type 3, and car type 4) arranged in respective columns (e.g., after order-car mapping algorithm steps i and ii). Further, network 602 shows connecting lines 612 connecting the order nodes to the respective predicted acceptable car type nodes (e.g., Order 1 to car types 1 and 2; Order 2 to car types 2 and 3; Order 3 to car types 1 and 2; and Order 4 to car type 3), which may be determined at order-car mapping algorithm step iii). Networks 604-608 show, for example, mapping of the orders to the car types under the mapping rule of order-car mapping algorithm step iv. Network 604, for example, shows mapping link 613 of Order 1 to car type 1. Next, network 604 shows mapping 614 of Order 2 to car type 2. Mapping of Order 3 to car type 1 may not be permitted as the only car of car type 1 is already allocated to Order 1. Similarly, mapping of Order 2 to car type 1 may not be permitted as the only car of car type 1 is already allocated to Order 1. However, as shown in network 608, Order 2 may be remapped (615) to car type 3 to allow mapping of another car (e.g., car type 3) which is not yet allocated. If remapping 615 is carried out, Order 1 can be re-mapped (616) to car 2, and Order 3 mapped (617) to car type 1. As shown in networks 604-608, there remain no substitute cars that can be mapped or allocated to Order 4.

After order and car mapping (as shown, for example, in FIG. 6), method 500 may calculate values for the key objectives (e.g., order fulfillment rate, Average NPS and profit) for the orders. In the foregoing example scenario, these key objectives may be calculated, for example, as follows: Order fulfillment rate,

$${f}_{1} = \frac{{\sum }_{i}^{N} {F}_{i}}{N} ,$$

In the above example,

$${f}_{1} = \frac{3}{4} = 0.75 ;$$

### Average NPS,

$${f}_{2} = \frac{{\sum }_{i}^{N} {S}_{i}}{{\sum }_{i}^{N} {F}_{i}} ,$$

Using the predicted NPS Iᵢₖ already calculated in stage one (e.g., I₁₂=6, I₂₃=7, I₃₁=8),

$${f}_{2} = \frac{6 + 7 + 8}{3} = 7 ;$$

and profit, f₃=Σᵢ^{N}FᵢDᵢ ((1−Uᵢ)(P_{G}_{ᵢ}−Q_{G}_{ᵢ}) Uᵢ(P_{C}_{ᵢ}−Q_{C}_{ᵢ})). Assuming that in the above example no orders have an upgraded car and the rental period is one day for all orders, then P₁=20, Q₁=5, P₂=15, Q₂=3, P₃=30, Q₃=10 and f₃=(20−5)+(15−3)+(30−10)=47.

An example iterative algorithm, which may be used by system 100 for implementing method 500, is described below

### Example Iterative Algorithm

1) t=0, Initialize the following input parameters:
   Iₘₐₓ: Maximum iterations
   Np: Number of particles
   wᵢ: Weight of inertia for Xᵢ
   c₁, c₂: Learning parameters
   RC: Acceptability rate for compatible car types
   RU: Acceptability rate for upgradable car types
2) Predict acceptability of car types
3) For all car types, calculate the value range R₁
4) Initialize the position vector X and velocity vector V of all particles subject to the constraints: 0<Xⱼ≦Rⱼ, j=1,2, . . . , M; and −Rⱼ<Vⱼ≦Rⱼ, j=1,2, . . . M
5) Normalize the initial solution by the decoding method and order and car mapping method. Calculate order fulfillment rate, average NPS and profit.
6) For each particle calculate the fitness value f₁, f₂, f₃ separately.
7) Set pbest₁ (pbest for f₁), pbest₂ (pbest for f₂), pbest₃ (pbest for f₃) to the current position.
8) Set gbest₁ (gbest for f₁), gbest₂ (gbest for f₂), gbest₃ (gbest for f₃) to the current optimal position of the particle with each maximum objective function value.
9) Set iteration index t=t+1
10) Update w by the following formula in order to decrease the search range gradu-ally.

$${w}_{i}^{′} = w \frac{{I}_{max} - t}{{I}_{max}}$$

11) Calculate agbest and dgbest using the following formulas:

agbest=average(gbest₁,gbest₂,gbest₃)

dgbest=distance(gbest₁,gbest₂,gbest₃)
12) For each particle, calculate dgbest

dgbest=distance(pbest₁,pbest₂,pbest₃)
13) For each particle, update pbest according to the following rule: if dgbest is less than dgbest, pbest will be selected from pbest₁, pbest₂, pbest₃ random-ly; Otherwise pbest=average(pbest₁, pbest₂, pbest₃)
14) Update the velocity and position of the particle i according to the following formulas and rules

Vᵢ′=wᵢVᵢ+c₁r₁(pbestᵢ−Xᵢ)+c₂r₂(agbestᵢ−Xᵢ)

Xᵢ′=Xᵢ+Vᵢ′,
where Vᵢ and Xᵢ are vectors before the update, while Vᵢ′ and Xᵢ′ are vectors after the update; where r₁ and r₂ are random number between 0 and 1; where pbestᵢ means the optimal position of particle i, while agbestᵢ means the global optimal position; and
   if Vᵢ′ or Vᵢ′ breaks the constraints in 4), replace with the boundary value.
15) Normalize current solution by the decoding method and order & car mapping method. Calculate order fulfillment rate, average NPS and profit.
16) For each particle calculate the fitness value f₁, f₂, f₃ separately.
17) Update pbest₁ (pbest for f₁), pbest₂ (pbest for f₂), pbest₃ (pbest for f₃).
18) Update
   gbest₁ (gbest for f₁), gbest₂ (gbest for f₂), gbest₃ (gbest for f₃).
19) If t=Iₘₐₓ, output all pbest and end the procedure. Otherwise go to 9.

It will be noted that steps 1-8 of the foregoing algorithm relate to initializing a solution, which is then iteratively optimized through steps 9-19.

In an example scenario, at step 8, three particles may be initialized, for example, as Particle 1: f₁=0.6, f₂=8, f₃=100; Particle 2: f₁=0.7, f₂=7, f₃=300; and Particle 3: f₁=0.8, f₂=6, f₃=200. Then gbest₁ is the current position of particle 3, gbest₂ is the current position of particle 1, gbest₃ is the current position of particle 2. Further assuming that each vertex has 2 dimensions, gbest₁=<2,5>, gbest₂=<3,4>, gbest₃=<4,3>.

Then, at step 11,

$$agbest = average ( < 2 , 5 > , < 3 , 4 > , < 4 , 3 > ) = < \frac{2 + 3 + 4}{3} , \frac{5 + 4 + 3}{3} >= < 3 , 4 > ;$$

$$and$$

$$dgbest = distance ( < 2 , 5 > , < 3 , 4 > , < 4 , 3 > ) = distance ( < 2 , 5 > , < 3 , 4 > ) + distance ( < 2 , 5 > , < 4 , 3 > ) + distance ( < 3 , 4 > , < 4 , 3 > ) = \sqrt{{( 2 - 3 )}^{2} + {( 5 - 4 )}^{2}} + \sqrt{{( 2 - 4 )}^{2} + {( 5 - 3 )}^{2}} + \sqrt{{( 3 - 4 )}^{2} + {( 4 - 3 )}^{2}} = \sqrt{2} + \sqrt{8} + \sqrt{2} .$$

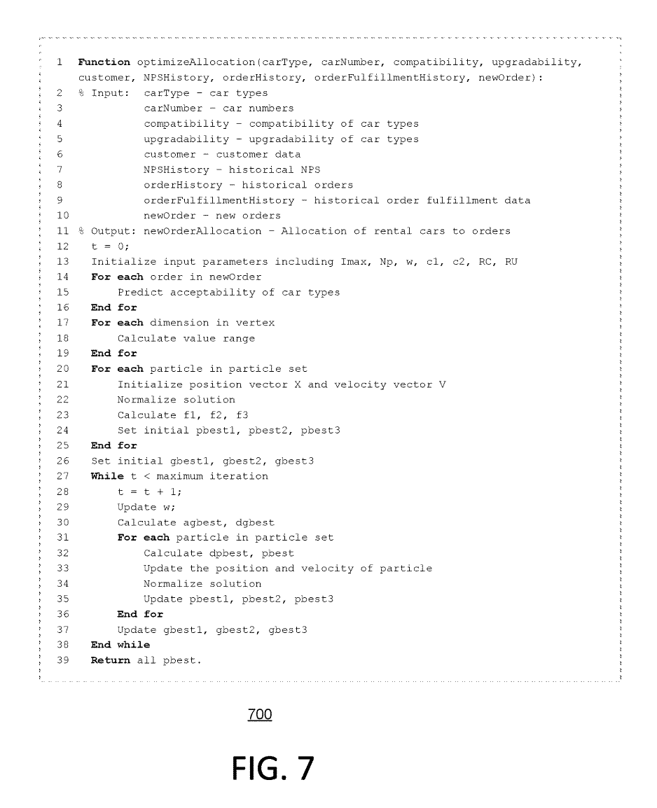

FIG. 7 shows example pseudo-code 700, which may be used for performing the elements of method 500 described above. Pseudo-code 700 or similar code may be used, for example, to configure the modules or processes of multi-objective optimizer (e.g., particle handler 110 and objective calculator 120, etc.) to implement method 500.

The various systems and techniques described herein may be implemented in digital electronic circuitry, or in computer hardware, firmware, or in combinations of them. The various techniques may implemented as a computer program product, i.e., a computer program tangibly embodied in a machine readable storage device, for execution by, or to control the operation of, data processing apparatus, e.g., a programmable processor, a computer, or multiple computers.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for utilizing substitutable assets that can be used as substitutes to fulfill orders for specific assets, the method comprising;
predicting acceptability of different asset types of the substitutable assets as substitutes for the specific assets requested in each of the orders;
selecting a pool of to-be-allocated assets including acceptable substitutable assets for the orders; and
allocating selected assets from the pool to fulfill each of the orders according to a multi-objective vector optimization solution.

2. The computer-implemented method of claim 1, wherein predicting acceptability of different asset types of the substitutable assets as substitutes for the specific assets includes predicting acceptability based on historical order fulfillment information, asset compatibility information and asset upgradability information.

3. The computer-implemented method of claim 1, wherein allocating selected assets from the pool to fulfill each of the orders includes mapping individual orders to individual assets.

4. The computer-implemented method of claim 3, wherein mapping individual orders to individual assets includes mapping each order to only one asset or none, and conversely, mapping each asset to only one order or none.

5. The computer-implemented method of claim 3, further comprising, after mapping individual orders to individual assets, calculating values of one or more multi-objective functions.

6. The computer-implemented method of claim 1, further including, obtaining the multi-objective vector optimization solution using particle swarm optimization to select the pool of to-be-allocated assets.

7. The computer-implemented method of claim 1, wherein obtaining the multi-objective vector optimization solution using particle swarm optimization includes:
initializing a position vector X and velocity vector V of a particle as an initial solution;
normalizing the initial solution by rounding real values to the next highest integer value, mapping orders to assets, and separately calculating values for each of the multi-objective functions;
calculating fitness values for each of the multi-objective functions separately;
setting a personal best (pbest) for each of the multi-objective functions to a current particle position; and
setting a global best(gbest) for each of the multi-objective functions to the current optimal position of the particle with each maximum objective function value.

8. A computer system for utilizing substitutable assets that can be used as substitutes to fulfill orders for specific assets, the system comprising a memory and a semiconductor-based processor, the memory and the processor forming one or more logic circuits configured to:
predict acceptability of different asset types of the substitutable assets as substitutes for the specific assets requested in each of the orders;
select a pool of to-be-allocated assets including acceptable substitutable assets for the orders; and
allocate selected assets from the pool to fulfill each of the orders according to a multi-objective vector optimization solution.

9. The computer system of claim 8, wherein the one or more logic circuits are configured to predict acceptability of different asset types of the substitutable assets as substitutes for the specific assets by predicting acceptability based on historical order fulfillment information, asset compatibility information and asset upgradability information.

10. The computer system of claim 8, wherein the one or more logic circuits are configured to allocate selected assets from the pool to fulfill each of the orders by mapping individual orders to individual assets.

11. The computer system of claim 10, wherein the one or more logic circuits are configured to map each order to only one asset or none, and conversely, map each asset to only one order or none.

12. The computer system of claim 10, wherein the one or more logic circuits are configured to, after mapping individual orders to individual assets, calculate values of one or more multi-objective functions.

13. The computer system of claim 8, wherein the one or more logic circuits are configured to obtain the multi-objective vector optimization solution using particle swarm optimization to select the pool of to-be-allocated assets.

14. The computer system of claim 8, wherein the one or more logic circuits are configured to obtain the multi-objective vector optimization solution by:
initializing a position vector X and velocity vector V of a particle as an initial solution;
normalizing the initial solution by rounding real values to the next highest integer value, mapping orders to assets, and separately calculating values for each of the multi-objective functions;
calculating fitness values for each of the multi-objective functions separately;
setting a personal best (pbest) for each of the multi-objective functions to a current particle position; and
setting a global best(gbest) for each of the multi-objective functions to the current optimal position of the particle with each maximum objective function value.

15. A non-transitory computer readable storage medium having instructions stored thereon, including instructions which, when executed by a microprocessor, cause a computer system to generate a resource plan utilizing substitutable assets that can be used as substitutes to fulfill orders for specific assets by:
predicting acceptability of different asset types of the substitutable assets as substitutes for the specific assets requested in each of the orders;
selecting a pool of to-be-allocated assets including acceptable substitutable assets for the orders; and
allocating selected assets from the pool to fulfill each of the orders according to a multi-objective vector optimization solution.

16. The non-transitory computer readable storage medium of claim 15, wherein predicting acceptability of different asset types of the substitutable assets as substitutes for the specific assets includes predicting acceptability based on historical order fulfillment information, asset compatibility information and asset upgradability information.

17. The non-transitory computer readable storage medium of claim 15, wherein allocating selected assets from the pool to fulfill each of the orders includes mapping individual orders to individual assets.

18. The non-transitory computer readable storage medium of claim 17, wherein the instructions, when executed by a microprocessor, further cause the computer system to, after mapping individual orders to individual assets, calculate values of one or more multi-objective functions.

19. The non-transitory computer readable storage medium of claim 15, wherein the instructions, when executed by a microprocessor, further cause the computer system to obtain the multi-objective vector optimization solution using particle swarm optimization to select the pool of to-be-allocated assets.

20. The non-transitory computer readable storage medium of claim 15, wherein the instructions, when executed by a microprocessor, further cause the computer system to: obtaining the multi-objective vector optimization solution using particle swarm optimization by:
initializing a position vector X and velocity vector V of a particle as an initial solution;
normalizing the initial solution by rounding real values to the next highest integer value, mapping orders to assets, and separately calculating values for each of the multi-objective functions;
calculating fitness values for each of the multi-objective functions separately;
setting a personal best (pbest) for each of the multi-objective functions to a current particle position; and
setting a global best (gbest) for each of the multi-objective functions to the current optimal position of the particle with each maximum objective function value.
